(19) United States
(12) Patent Application Publication
(10) Pub. No.: US 2009/0100241 A1
(43) Pub. Date: Apr. 16, 2009

(54) Method for Removing a Mass Storage System From a Computer Network, and Computer Program Product and Computer Network for Carrying our the Method

(76) Inventor: Steffen Werner, Munich (DE)

Correspondence Address: COHEN, PONTANI, LIEBERMAN & PAVANE LLP, 551 FIFTH AVENUE, SUITE 1210, NEW YORK, NY, 10176, US

(21) Appl. No.: 11/886,824

(22) PCT Filed: Feb. 7, 2006
(86) PCT No.: PCT/DE2006/000201

§ 371 Date: Apr. 29, 2008

(30) Foreign Application Priority Data
Mar. 23, 2005 (DE) 10 2005 013 502.1

(51) Int. Cl. G06F 12/00; G06F 3/06

(52) U.S. Cl. 711/165; 711/E12.001

(57) ABSTRACT

A method for removing a mass storage system from a composite computer system. The composite computer system comprises a multiplicity of mass storage systems which respectively provide at least one file system for storing data, at least one component computer for carrying out one or more processes, a network which connects the multiplicity of mass storage systems to the at least one component computer and an access controller which controls access by the processes to the file systems which have been provided. A mass storage system to be removed is first of all selected. All of the file systems provided by the selected mass storage system are then marked. The marked file systems are released by copying data and diverting access by processes to the copied data from the marked file system to at least one file system which has not been marked. After the releasing operation has been concluded, it is signaled that the selected mass storage system can be removed from the composite computer system.

The invention relates to a method for removing a mass storage system from a composite computer system, the mass storage system being removed during ongoing operation of the composite computer system.

As a result of the increasing centralization of computer services, the computer systems needed to carry out the services are continuing to grow. A network of a plurality of simple component computers, which can be easily expanded by adding further component computers, is often used instead of an individual mainframe computer or a few mainframe computers.

In the case of such composite computer systems, it is known practice to use component computers which have a relatively simple design and provide the requisite computing power and the associated main memory. Furthermore, it is known practice to use mass storage systems, which have been specially set up and provide large amounts of storage capacity, in such composite computer systems. For example, RAID (Redundant Array of Independent Disks) systems which combine the storage capacity of a plurality of magnetic disk stores, which are installed in the RAID system, to form a logic memory device which provides the composite computer system with a single file system for storing data in a highly available manner are suitable for this purpose. Particularly large mass storage systems may also provide a plurality of logic memory devices or file systems. This is particularly necessary when the storage capacity of the mass storage system exceeds the size of the address space of the file system being used.

EP 1 234 226 discloses a backup and archiving system in which a composite computer system is used to centrally provide tape drives for a multiplicity of data processing systems. The known archiving system comprises, on the one hand, component computers which receive data from external data processing systems and, on the other hand, component computers which back up the data on tape cassettes. In order to increase the efficiency of the system, the data to be backed up are buffered in this case in a file system which is provided by one or more mass storage systems and is managed by a further component computer.

Mass storage systems which are particularly failsafe are used in the composite computer system described. For example, data in the individual mass storage systems may be redundantly backed up in different mass memories, with the result that, when a mass memory fails, the data of the respective other mass memory can be used.

Despite the measures described above, it may be necessary to remove individual mass storage systems from the composite computer system, for example in order to replace a defective mass memory with a new one or in order to expand the capacity of the mass storage system. However, such removal of a mass storage system constitutes considerable intervention in the design of the composite computer system.

One simple possible way of removing a mass storage system from a composite computer system is to shut down or switch off the entire composite computer system. In this state, the necessary maintenance work can be carried out on the mass storage system. After the maintenance work has been concluded, the composite computer system must be put into operation again. In this case, it is disadvantageous that all of the services provided by the composite computer system are not available while carrying out the maintenance work.

Another possibility is to stop individual processes which run on one or more component computers and access a mass storage system to be removed, to back up suitable data and metadata of the mass storage system and to then block further access to the file systems of the mass storage system. In Unix systems, the file systems can be blocked, for example, by using the command “umount” which removes individual mass storage systems from a network-wide file system. The maintenance work can then be carried out on the mass storage system without switching off or shutting down the entire composite computer system.

After the maintenance work has been concluded, the file systems provided by the mass storage system must first of all be made available again in the composite computer system, for example by using the Unix command “mount”. Data which have possibly been changed by the maintenance work must be restored using the data which have been backed up and metadata, so that a difference to the state before carrying out the maintenance work cannot be discerned for the processes which have been stopped. As the last step, the processes which have been stopped must be restarted. In this case, it may be necessary to restart one or more of the component computers.

Stopping individual processes makes it possible to avoid switching off the composite computer system completely. However, the computer services which are normally provided by one of the stopped processes are not available in this case either during the maintenance work. Furthermore, such a procedure is very complex, with the result that the maintenance work which has been carried out can easily give rise to an error in the composite computer system.

Therefore, the invention is based on the object of describing a method which makes it possible to remove a mass storage system from the running composite computer system without disrupting the computer services provided by the composite computer system.

According to the invention, the object is achieved by means of a method as claimed in patent claim 1.

According to the invention, data from processes which run on the component computers are shifted to file systems which are provided by other mass storage systems. To this end, a mass storage system which is intended to be removed from a composite computer system is first of all selected. All file systems which are provided by the selected mass storage system are then marked. Before it is possible to remove the mass storage system from the composite computer system, all marked file systems must be released from use by processes of the composite computer system. To this end, new access by processes to one of the marked file systems is prevented, on the one hand. Furthermore, data which are already contained in a marked file system are copied to another file system. In this case, access to the already existing data is diverted to the copied data.

It is important for the method according to the invention that all access to data of the composite computer system is carried out by a central access controller. The access controller ensures that the marked file systems are released and diverts access to file systems which have not been marked. A component computer which accesses the data of the mass storage system does not notice anything concerning its release. The computer services provided by the composite computer system are likewise not disrupted by the intervention. After concluding release of all of the marked file systems, it is signaled that the selected mass storage system can be removed from the composite computer system.

It is advantageous for a mass storage system which has been removed from the composite computer system according to the invention to be able to be incorporated into the composite computer system again. Following maintenance work which is possibly carried out on the mass storage system, the composite computer system is informed that the selected mass storage system is intended to be used again. After it has been ensured that the mass storage system to be used again is ready for operation, it is signaled to the access controller that the file systems provided by the mass storage system are available for storing data again.

In this case, the access controller may provide, for example, a strategy according to which new access is diverted to file systems of the mass storage system to be used again. Alternatively, it is also possible for data which were already stored in the file systems provided by the selected mass storage system before the latter was removed to be copied back to the file systems provided by the selected mass storage system. This makes it possible, for example, to uniformly load all mass storage systems of the composite computer system.

Further details and refinements of the invention are specified in the subclaims.

The invention is explained in more detail below in an exemplary embodiment and with reference to the drawings, in which:

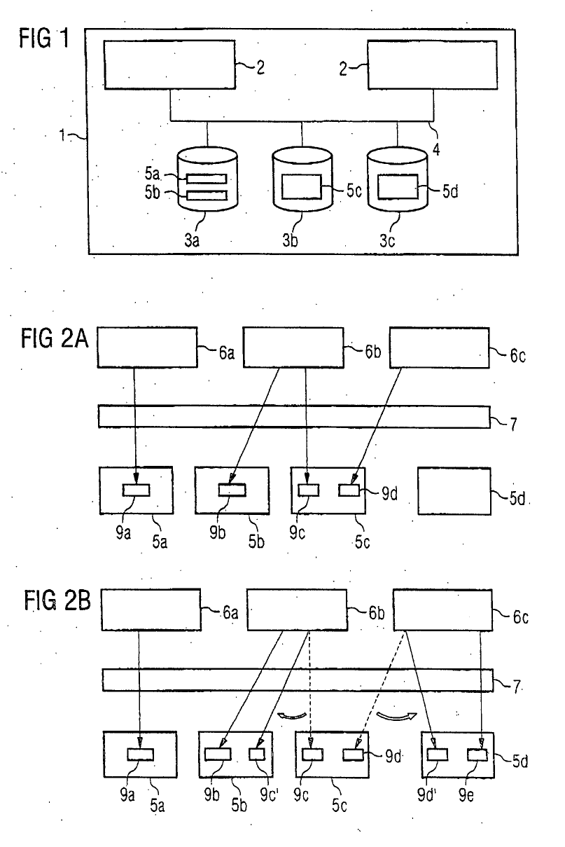

FIG. 1 shows a diagrammatic illustration of a composite computer system for carrying out the method according to the invention,

FIG. 2 shows a diagrammatic illustration of processes which access different file systems via an access controller,

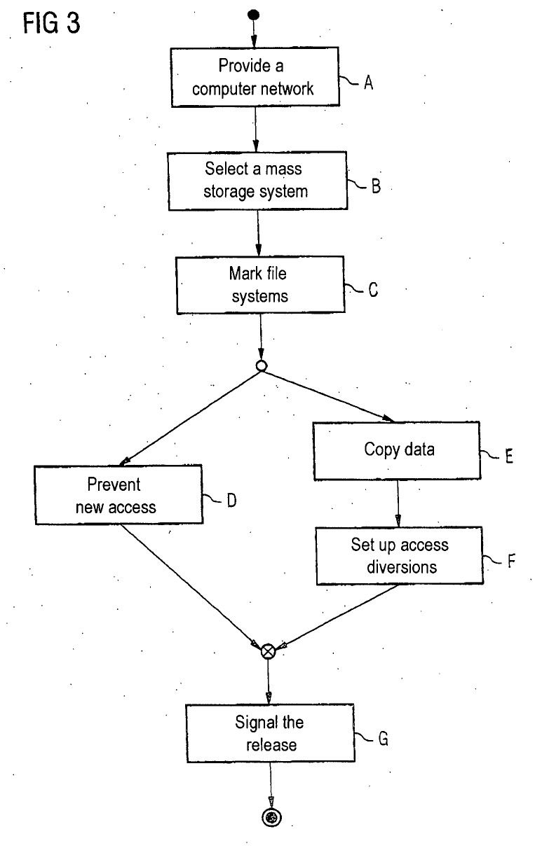

FIG. 3 shows a flowchart for the method according to the invention.

FIG. 1 shows the diagrammatic illustration of a composite computer system 1. The composite computer system 1 comprises two component computers 2 and three mass storage systems 3. The mass storage systems 3 each comprise one or more file systems 5. The component computers 2 and the mass storage systems 3 are connected to one another by means of a network 4. A particularly powerful type of network, for example a so-called Storage Area Network (SAN) which allows components 2 and 3 which are set up at a great distance from one another to be connected at high speed, is preferably used as the network 4 in this case. In the exemplary embodiment, the network 4 is a so-called fiber channel network.

FIG. 2 shows a diagrammatic illustration of data access in one exemplary embodiment in accordance with the method according to the invention. FIG. 2A shows that three processes 6 access four file systems 5 via a common access controller 7 in the exemplary embodiment. In this case, a first process 6a accesses first data 9a in the file system 5a, a second process 6b accesses second data 9b in the file system 5b and third data 9c in the file system 5c and a third process 6c accesses fourth data 9d in the file system 5c.

In the exemplary embodiment, the mass storage system 3b is intended to be removed from the composite computer system 1. The mass storage system 3b provides a single file system 5c.

In FIG. 2B, the file system 5c was released by the access controller 7. To this end, the data 9c which are used by the process 6b were copied from the file system 5c to the file system 5b. Furthermore, the data 9d were copied from the file system 5c to the file system 5d. Access by the processes 6b and 6c to the data 9c and 9d is diverted by the access controller 7 to the file systems 5b and 5d, respectively. Furthermore, additional data 9e which are accessed by the process 6c were immediately positioned in the file system 5d, with the result that the file system 5c is no longer accessed now.

In one refinement of the invention, the access controller 7 waits for the end of access by the processes 6b and 6c before the data 9c and 9d are copied from the marked file system 5c to the unmarked file systems 5b and 5d and a diversion is set up for new access to the copied data 9c′ and 9d′. In this case, the end of access can be expressly determined by the applications 6b and 6c, for example by closing the associated files 9c and 9d, or can be automatically detected by the access controller 7, for example after a predetermined amount of time without use has been detected.

In another refinement, the operations of copying over data and diverting access take place during existing data access. This is particularly advantageous when a process 6 reads in very extensive data 9, for example when reading data 9 from a file system 5 which are intended to be written to a magnetic tape drive for data backup. Such a process may run over a relatively long period of time depending on the volume of data and tape drive used. In order to shorten the amount of time needed to release the mass storage system 3b, the data 9c and 9d are copied over to the file systems 5b and 5d as early as during existing access, so that access by slow processes 6 can be transparently diverted to the copied data 9c′ and 9d′. Alternatively, the access controller 7 may also temporarily stop a process 6 in order to allow the data 9c and 9d to be copied over and to set up a corresponding diversion.

The mass storage system 3b which solely provides the released file system 5c can now be removed from the composite computer system 1 without any problems. It is not necessary to stop the processes 6 or switch off the component computers 2 for this purpose.

The access controller 7 may be implemented, for example, as a further process 6 which runs on one or more of the existing component computers 2. It goes without saying that a separate component computer 2 which is solely used as an access controller 7 may also be integrated in the composite computer system 1.

After maintenance work has been concluded, the mass storage system 3b can be added to the composite computer system 1 again. The fact that the mass storage system 3b has been added to the composite computer system 1 is either explicitly communicated to the access controller 7 or is automatically detected by the access controller 7 in this case.

For example, the access controller 7 may attempt to access the mass storage system 3b at regular intervals. If such an access attempt is successful, the access controller 7 assumes that the mass storage system 3b is available again. The actuation of a control element which is set up for this purpose, preferably in the mass storage system 3b, or the transmission of a command to the access controller 7, for example by using a control console, can also be used to communicate that the mass storage system 3b is ready for operation.

The access controller 7 can then allocate new requests for additional storage space for data 9 from the processes 6 to the mass storage system 5c. In this manner, the mass storage system 5c which has been added again is slowly integrated into the composite computer system 1 without it being necessary to copy over data 9 in this case.

Alternatively, the data 9c′ and 9d′ which have previously been shifted can also be copied back from the file systems 5b and 5d to the file system 5c provided by the mass storage system 3b. The access controller 7 advantageously copies back only those data 9 which changed after releasing the file system 5c. After the copying-back operation has been concluded, access by the processes 6b and 6c to the data 9c and 9d is diverted to the file system 5c again. This makes it possible to uniformly load the file systems 5 and thus the mass storage systems 3.

FIG. 3 shows a flowchart of the method according to the invention. In a first step A, a composite computer system 1 is provided. In this case, the composite computer system 1 which has been provided comprises at least two mass storage systems 3, which respectively provide one or more file systems 5, as well as one or more component computers 2 which are connected to one another via a network 4. The composite computer system 1 also comprises a central access controller 7 which is used to coordinate all access by the component computers 2 to the file systems 5 of the mass storage systems 3.

In a step B, one of the mass storage systems 3 of the composite computer system 1 is selected. The selection can be made manually, for example, by actuating an input element which is accommodated in the mass storage system 3 or by transmitting a command to the access controller 7. It is also possible for the access controller 7 to automatically detect and select a mass storage system 3 to be maintained. To this end, a mass storage system 3, for example, may provide the access controller 7 with statistical information relating to errors which have been detected, such as the number of defective sectors or blocks of a mass memory, or other operating parameters, such as the operating temperature or the magnitude of a supply voltage, using an interface which has been set up for this purpose. When a predefined limit value is exceeded, the associated mass storage system 3 is automatically selected by the access controller 7.

In a step C, all file systems 5 which are provided by the selected mass storage system 3 are marked. This may be effected, for example, by marking or deleting a table entry in a first table which is managed by the access controller 7 and in which all of the available file systems 5 are entered.

In the case of subsequent requests to the access controller 7 for new storage space for storing data 9 from processes, the access controller 7 prevents further access to the marked file systems 5 in step D. Instead, such requests are forwarded to one of the file systems 5 which have not been marked. In this case, the first table of the access controller 7, for example, can be used to select file systems 5 which have not been marked for release.

In a step E, data 9 which already exist in the marked file system 5 are copied to another mass storage system 5. After the copying operation has been concluded, a diversion for access to the copied data 9 is set up in a step F. In this case, the access controller 7 can use, for example, a second allocation table in which the copied data record 9′ in a file system 5 which has not been marked is recorded for each data record 9 of the marked file system 5 which has been copied over. Alternatively, the access controller may also use a database in which the position in one of the data systems 5 which is to be currently used is listed for each record of data 9. That is to say, each access by a process 6 to data 9 takes place using the second allocation table of the access controller 7, even for those data which have not been copied over while releasing a file system 5. The practice of setting up symbolic links, as are known from Unix file systems for example, can also be used to divert access.

In a last step G, it is signaled to a user that the mass storage system 3 selected in step B can be safely removed from the composite computer system 1.

### LIST OF REFERENCE SYMBOLS

1 Composite computer system
2 Component computer
3 Mass storage system
4 Network
5 File system
6 Process
7 Access controller
9 Data
A to G Method steps

1. A method for removing a mass storage system from a composite computer system wherein the method comprises the steps of:
providing a composite computer system comprising:
(a) a multiplicity of mass storage systems which have a unique identifier and respectively provide at least one file system for storing data,
(b) at least one component computer for carrying out one or more processes,
(c) a network which connects the multiplicity of mass storage systems to the at least one component computer,
(d) an access controller which is central to all component computers and controls access by the processes to the file systems which have been provided;
selecting a mass storage system which is intended to be removed from the composite computer system;
marking all file systems which are provided by the selected mass storage system;
releasing all marked file systems by
(a) using the access controller to prevent new access by processes to the marked file systems,
(b) copying the data contained in the marked file systems to at least one file system which is provided by a mass storage system other than that selected and is not marked,
(c) using the access controller to divert all access by the processes to data in the marked file system to the copied data in the file system which has not been marked, and
(d) signaling that the selected mass storage system can be removed from the composite computer system after the releasing operation has been concluded, so that no other process accesses the selected mass storage system.

2. The method as claimed in claim 1,
wherein
before the step of copying data, the access controller waits for the end of all access by processes to these data.

3. The method as claimed in claim 1,
further comprising the steps of:
recording the unique identifier of the mass storage system which was selected in the selection step,
detecting that the mass storage system having the recorded identifier is ready for operation after signaling, and
using the access controller to allow new access by processes to the file system provided by the mass storage system having the recorded identifier after readiness for operation has been detected.

4. The method as claimed in claim 3,
in which the following steps are additionally carried out after the step in which readiness for operation is detected:
the data which have been copied to the other file system(s) are copied back to the file systems of the mass storage system having the recorded identifier if the copied data have been changed since being copied, and
all access by the processes to copied data in the other file system(s) is diverted to the data which have been copied back to the file systems of the mass storage system having the recorded identifier.

5. The method as claimed in claim 1, wherein,
the access controller sets up symbolic links between the data and the copied data in the diverting step.

6. The method as claimed in claim 1, wherein
the access controller comprises a database containing the positions of all data which are stored in the mass storage systems, and the entry of the data in the database is changed in the step of diverting access to the effect that it refers to the copied data (9′).

7. The method as claimed in claim 1, wherein
the composite computer system is set up to buffer data, the data to be buffered being written by at least one first component computer to a file system of a mass storage system and being read by at least one second component computer from a file system of a mass memory.

8. The method as claimed in claim 7, wherein
the composite computer system provides a central data backup service, the at least one first component computer receiving data to be backed up via an interface which has been provided and the at least one second component computer writing the data to be backed up to a tape drive.

9. A computer program product having program code for carrying out a method as claimed in claim 1, if the program code runs on a component computer of the composite computer system.

10. A composite computer system comprising:
at least one component computer for carrying out processes;
at least two mass storage systems for storing data;
at least one network for connecting the at least one component computer to the at least two mass storage systems, and
an access controller which is central to all component computers, is adapted to coordinate access by the processes to the data and is set up to carry out a method as claimed in claim 1.
